(19) United States
(12) Patent Application Publication
(10) Pub. No.: US 2022/0203765 A1
(43) Pub. Date: Jun. 30, 2022

(54) BOLTED JOINT FOR AN AXLE ASSEMBLY

(71) Applicant: Dana Heavy Vehicle Systems Group, LLC, Maumee, OH (US)

(72) Inventors: Edwin O. Swinehart, JR., Toledo, OH (US); Wendy J. Blankenship, Huron, OH (US); Gerald J. Mack, Swanton, OH (US); Steven T. Byrne, Holland, OH (US)

(21) Appl. No.: 17/139,752

(22) Filed: Dec. 31, 2020

(51) Int. Cl. B60B 35/16; B60B 35/12; B60K 17/16

(52) U.S. Cl. CPC B60B 35/16; B60K 17/165; B60B 35/125

(57) ABSTRACT

An axle assembly for a vehicle including a carrier housing and an axle tube housing configured to receive an axle shaft therein. The axle tube housing is coupled to the carrier housing by at least one fastener extending outwardly from an interior of the carrier housing into at least one aperture formed in the axle tube housing. A joint formed between the axle tube housing and the carrier housing is nonorthogonal relative to a centerline of the axle shaft.

### FIELD

The presently disclosed subject matter relates to an axle assembly, and more particularly to a bolted joint for an axle assembly.

### BACKGROUND

Conventionally, a motor vehicle drive axle assembly may include a carrier housing, a pair of axle tube housings coupled to opposite sides of the carrier housing, and a pair of axle shafts rotatably supported at least partially within the axle tube housings. A gear-set in the carrier housing includes a pinion that connects a drive shaft to a differential assembly through the gear set. The differential assembly transmits torque and rotation to the axle shafts through pinions, and allows relative rotation between wheels of the motor vehicle.

In prior art axle assemblies, the carrier housing has the axle tube housings bolted thereto forming a bolted joint between the carrier housing and each of the axle tube housings. The bolted joint is typically at a 90 degree angle relative to a centerline of the axle shaft. Since the carrier housing is conventionally formed by a die casting process, the carrier housing has a draft angle which needs to be overcome in order to produce the 90 degree angle of the bolted joint. Typically, the draft angle is compensated for by adding material to the carrier housing during casting to facilitate proper alignment between the threaded holes formed in the carrier housing and the holes formed axle tube housing. The additional material causes problems with solidification during casting of the carrier housing.

Accordingly, it would be desirable to produce an axle assembly including an axle tube housing bolted to the carrier housing with a non-square bolted-joint. As such, the additional material to compensate for the draft angle of the carrier housing of the prior art is not needed. Hence, the carrier housing with the non-square bolted joint is smaller and lighter, and thereby more cost effective.

### SUMMARY

In concordance and agreement with the present disclosure, an inter-axle differential assembly including a passive, mechanical locking system that will automatically lock and unlock the inter-axle differential assembly during certain pre-determined operating conditions, has surprisingly been discovered.

In one embodiment, an axle assembly, comprises: a carrier housing; and an axle tube housing coupled to the carrier housing, the axle tube housing is configured to receive an axle shaft therein, wherein a joint formed between the axle tube housing and the carrier housing is nonorthogonal relative to a centerline of the axle shaft.

In another embodiment, an axle assembly, comprises: a carrier housing; an axle tube housing coupled to the carrier housing, the axle tube housing configured to receive an axle shaft therein; a sealing element disposed between the carrier housing and the axle tube housing to form a substantially fluid-tight seal therebetween; and a fastener configured to couple the carrier housing to the axle tube housing forming a bolted joint between the carrier housing and the axle tube housing, wherein the bolted joint is nonorthogonal relative to a centerline of the axle shaft.

In yet another embodiment, a method of providing an axle assembly, comprises: providing a carrier housing; providing an axle tube housing configured to receive an axle shaft therein; and coupling the axle tube housing to the carrier housing, wherein a joint formed between the axle tube housing and the carrier housing is nonorthogonal relative to a centerline of the axle shaft.

As aspects of certain embodiments, an angle of a sealing surface of the carrier housing relative to the centerline of the axle shaft is equivalent to a predetermined draft angle of an interior surface of the carrier housing.

As aspects of certain embodiments, an angle of a sealing surface of the axle tube housing relative to the centerline of the axle shaft is equivalent to a predetermined draft angle of an interior surface of the carrier housing.

As aspects of certain embodiments, an angle of a sealing surface of the carrier housing relative to the centerline of the axle shaft is less than 90 degrees.

As aspects of certain embodiments, an angle of a sealing surface of the carrier housing relative to the centerline of the axle shaft is more than 90 degrees.

As aspects of certain embodiments, an angle of a sealing surface of the axle tube housing relative to the centerline of the axle shaft is less than 90 degrees.

As aspects of certain embodiments, an angle of a sealing surface of the axle tube housing relative to the centerline of the axle shaft is more than 90 degrees.

As aspects of certain embodiments, the axle tube housing is coupled to the carrier housing by at least one fastener extending outwardly from an interior of the carrier housing into at least one aperture formed in the axle tube housing.

As aspects of certain embodiments, at least one of the carrier housing and the axle tube housing is formed by a casting process.

### BRIEF DESCRIPTION OF THE DRAWINGS

The accompanying drawings are incorporated herein as part of the specification. The drawings described herein illustrate embodiments of the presently disclosed subject matter, and are illustrative of selected principles and teachings of the present disclosure. However, the drawings do not illustrate all possible implementations of the presently disclosed subject matter, and are not intended to limit the scope of the present disclosure in any way.

FIG. 1 is a fragmentary elevational view of an axle assembly for a vehicle including a carrier housing and an axle tube housing coupled thereto according to an embodiment of the presently described subject matter; and

FIG. 2 is a fragmentary cross-sectional view of the axle assembly shown in FIG. 1.

### DETAILED DESCRIPTION

It is to be understood that the presently disclosed subject matter may assume various alternative orientations and step sequences, except where expressly specified to the contrary. It is also to be understood that the specific assemblies and systems illustrated in the attached drawings, and described in the following specification are simply exemplary embodiments of the inventive concepts defined herein. Hence, specific dimensions, directions or other physical characteristics relating to the embodiments disclosed are not to be considered as limiting, unless expressly stated otherwise. Also, although they may not be, like elements in various embodiments described herein may be commonly referred to with like reference numerals within this section of the application.

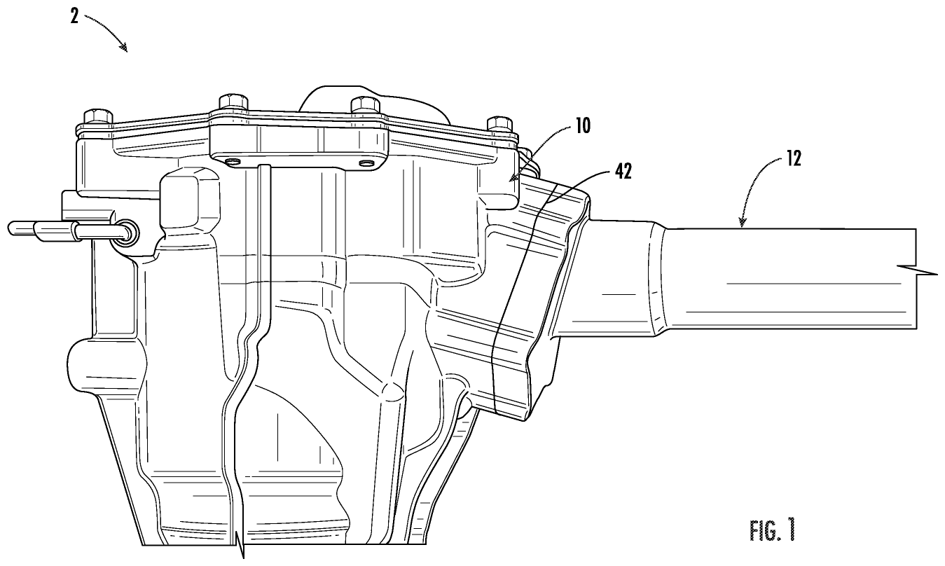

FIG. 1 illustrates an axle assembly 2 for a vehicle (not depicted). The axle assembly 2 may be used in any suitable vehicle as desired such as a passenger, commercial or agricultural truck, equipment, or vessel, for example. The axle assembly 2 may be first in the series and referred to as a front axle assembly or may be second in the series and referred to as a rear axle assembly. In certain embodiments, the axle assembly 2 is utilized in a vehicle drivetrain that may provide torque generated by a power source, e.g. an engine or motor, to the axle assembly 2 in order to propel the vehicle. The power source may be operatively coupled to an input of a transmission and an output of the transmission may be coupled to an input of the axle assembly 2, such as with a drive shaft (not depicted).

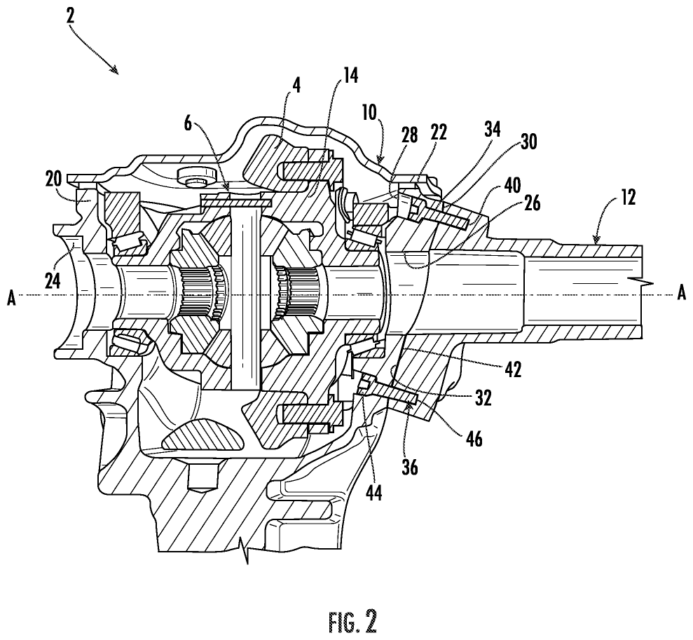

An input coupling, e.g. a pinion yoke, may facilitate coupling of the axle assembly 2 to the power source. For example, the input coupling may be operatively connected to the drive shaft. A drive pinion (not depicted) may be spaced apart from the input shaft and may be rotatable about a second axis. In certain embodiments, the second axis is spaced apart from and substantially parallel to the first axis. The drive pinion may extend through the driven gear and may not rotate with respect to the driven gear. The drive pinion may rotate with the driven gear about the second axis. The drive pinion may have a gear portion that may be disposed at an end of the drive pinion. The gear portion may include a set of teeth that mate with corresponding teeth on a ring gear 4 of a differential assembly 6, shown in FIG. 2.

In certain embodiments, the axle assembly 2 is provided to drive wheels (not depicted) supported on axle shafts (not depicted) extending outwardly from opposite sides of the axle assembly 2. The axle assembly 2 may include a carrier housing 10. The carrier housing 10 may receive various components of the axle assembly 2 and facilitate mounting of the axle assembly 2 to the vehicle. In at least one configuration, the carrier housing 10 may include a pair of axle tube housings 12 configured to receive the axle shafts therein.

The carrier housing 10 may be configured to support the differential assembly 6 therein for dividing torque between the axle shafts. The differential assembly 6 may transmit torque to the vehicle traction wheel assemblies and permit the traction wheel assemblies to rotate at different velocities in a manner known by those skilled in the art. As shown in FIG. 2, the ring gear 4 may be fixedly mounted on a case 14 of the differential assembly 6. The ring gear 4 may have teeth that may mesh with the gear portion of the drive pinion. Rotation of the drive pinion may rotate the ring gear 4 and the case 14 about a third axis. The ring gear 4 may be operatively connected to the axle shafts by the differential assembly 6. As such, the differential assembly 6 may receive torque via the ring gear 4 and provide torque to the axle shafts.

The axle shafts may transmit torque from the differential assembly 6 to corresponding traction wheel assemblies. Each axle shaft may extend through the axle tube housings 12. The axle shafts may extend along and may be rotated about the third axis by the differential assembly 6. Each axle shaft may have a first end and a second end. The first end may be coupled to the differential assembly 6. The second end may be disposed opposite the first end and may be operatively connected to a wheel end assembly that may have a wheel hub that may support a wheel.

The axle tube housings 12 respectively define a housing left side 20 and a housing right side 22. The housing left side 20 defines an axle tube opening 24 configured to receive one of the axle shafts. Similarly, the housing right side 22 defines an axle tube opening 26 configured to receive another one of the axle shafts.

In certain embodiments, the carrier housing 10 is produced from aluminum or an aluminum alloy using a die casting process. Use of aluminum or aluminum alloy is critical to the manufacture because it provides significant mass reduction relative to a cast iron carrier housing. Alternatively, other light-weight materials or alloys thereof may be used in the manufacture of carrier housing 10 to provide the benefits described herein. For example, carrier housing 10 may be produced from magnesium or a magnesium alloy. This mass reduction results in increased vehicle fuel efficiency. However, a predetermined draft angle for an interior surface 28 of the carrier housing 10 relative to a centerline A-A of the axle shaft is required in order for carrier housing 10 to be formed using the die casting process. In certain embodiments, the predetermined draft angle of the interior surface 28 of the carrier housing 10 relative to the centerline A-A of the axle shaft may be generally nonorthogonal or more or less than 90 degrees. For example, the predetermined draft angle of the interior surface 28 of the carrier housing 10 may be 92 degrees relative to the centerline A-A of the axle shaft.

As shown, the carrier housing 10 is formed with a sealing surface 30. It should be appreciated that the sealing surface 30 may be formed by any suitable forming process as desired such as a casting process or a machining process, for example. In certain embodiments, the sealing surface 30 of the carrier housing 10 may be formed at an angle relative to the centerline A-A of the axle shaft equivalent to the predetermined draft angle of the interior surface 28 of the carrier housing 10. As such, the interior surface 28 of the carrier housing 10 may be substantially parallel to the sealing surface 30 thereof. In certain embodiments, the angle of the sealing surface 30 of the carrier housing 10 relative to the centerline A-A of the axle shaft may be generally nonorthogonal or more or less than 90 degrees. For example, the angle of the sealing surface 30 of the carrier housing 10 may be 92 degrees relative to the centerline A-A of the axle shaft.

Similarly, at least one of the axle tube housings 12 includes a sealing surface 32. It should be appreciated that the sealing surface 32 may be formed by any suitable forming process as desired such as a casting process or a machining process, for example. The sealing surface 32 may be configured to mate with the sealing surface 30 of the carrier housing 10 to form a joint therebetween. A sealing element (not depicted), such as a gasket or an O-ring, for example, may be disposed between the sealing surfaces 30, 32 to form a substantially fluid-tight seal between the carrier housing 10 and the axle tube housing 12. In certain embodiments, the sealing surface 32 of the axle tube housing 12 may be formed at an angle relative to the centerline A-A of the axle shaft equivalent to at least one of the predetermined draft angle of the interior surface 28 of the carrier housing 10 and the angle of the sealing surface 30 of the carrier housing 10. As such, the sealing surface 32 of the axle tube housing 12 may be substantially parallel to at least one of the interior surface 28 and the sealing surface 30 of the carrier housing 10. In certain embodiments, the angle of the sealing surface 32 of the axle tube housing 12 relative to the centerline A-A of the axle shaft may be generally nonorthogonal or more or less than 90 degrees. For example, the angle of the sealing surface 32 of the axle tube housing 12 may be 92 degrees relative to the centerline A-A of the axle shaft.

At least one through bore 34 may be formed in the carrier housing 10 extending from the interior surface 28 to the sealing surface 30 thereof. In certain embodiments, the at least one through bore 34 may be formed substantially perpendicular to at least one of the interior surface 28 of the carrier housing 10 and the sealing surface 30 of the carrier housing 10. As illustrated, each of the at least one through bore 34 may configured to receive at least a portion of a fastener 36 (e.g. a threaded bolt) therein.

At least one corresponding aperture 40 may be formed in the sealing surface 32 of the axle tube housing 12. In certain embodiments, the at least one aperture 40 may be formed substantially perpendicular to at least one of the sealing surface 32, the interior surface 28 of the carrier housing 10, and the sealing surface 30 of the carrier housing 10. As illustrated, each of the at least one aperture 40 may aligned with the at least one through bore 34 and configured to receive at least a portion of the fastener 36 (e.g. a threaded bolt) therein. In certain embodiments, the at least one aperture 40 may include a plurality of threads formed on an inner surface thereof for threaded engagement with threads formed on an outer surface of the fastener 36. Accordingly, a bolted joint 42 is formed between the carrier housing 10 and the axle tube housing 12. As such, the carrier housing 10 does not require additional material to compensate for the predetermined draft angle of the carrier housing 10 as that required by the carrier housings of the prior art. Hence, the carrier housing 10 with the substantially nonorthogonal bolted-joint 42 does not encounter solidification issues during the casting process and is smaller and lighter, and thereby more cost effective than the prior art.

To assemble, the sealing element is disposed on the sealing surface 30 of the carrier housing 10. Thereafter, the axle tube housing 12 is disposed adjacent the sealing element and the carrier housing 10 having the apertures 40 of the axle tube housing 12 aligned with the corresponding through holes 34 of the carrier housing 10. One of the fasteners 36 is then inserted from the interior of the carrier housing 10 into each of the through holes 34 having a head 44 of the fasteners 36 abut the interior surface 28 of the carrier housing 10 to maintain a position of the fasteners 36 within the carrier housing 10. A threaded end 46 of each of the fasteners 34 extends through the through holes 34 and is received into the apertures 40 formed in the axle tube housing 12. Each of the fasteners 36 is then tightened forming the substantially fluid-tight bolted joint between the carrier housing 10 and the axle tube housing 12.

While various embodiments have been described above, it should be understood that they have been presented by way of example, and not limitation. It will be apparent to persons skilled in the relevant arts that the disclosed subject matter may be embodied in other specific forms without departing from the spirit or essential characteristics thereof. The embodiments described above are therefore to be considered in all respects as illustrative, not restrictive.

What is claimed is:

1. An axle assembly, comprising:
a carrier housing; and
an axle tube housing coupled to the carrier housing, the axle tube housing is configured to receive an axle shaft therein, wherein a joint formed between the axle tube housing and the carrier housing is nonorthogonal relative to a centerline of the axle shaft.

2. The axle assembly of claim 1, wherein an angle of a sealing surface of the carrier housing relative to the centerline of the axle shaft is equivalent to a predetermined draft angle of an interior surface of the carrier housing.

3. The axle assembly of claim 1, wherein an angle of a sealing surface of the axle tube housing relative to the centerline of the axle shaft is equivalent to a predetermined draft angle of an interior surface of the carrier housing.

4. The axle assembly of claim 1, wherein an angle of a sealing surface of the carrier housing relative to the centerline of the axle shaft is less than 90 degrees.

5. The axle assembly of claim 1, wherein an angle of a sealing surface of the carrier housing relative to the centerline of the axle shaft is more than 90 degrees.

6. The axle assembly of claim 1, wherein an angle of a sealing surface of the axle tube housing relative to the centerline of the axle shaft is less than 90 degrees.

7. The axle assembly of claim 1, wherein an angle of a sealing surface of the axle tube housing relative to the centerline of the axle shaft is more than 90 degrees.

8. The axle assembly of claim 1, wherein at least one fastener extends outwardly from an interior of the carrier housing into at least one aperture formed in the axle tube housing.

9. The axle assembly of claim 1, wherein at least one of the carrier housing and the axle tube housing is formed by a casting process.

10. An axle assembly, comprising:
a carrier housing;
an axle tube housing coupled to the carrier housing, the axle tube housing configured to receive an axle shaft therein;
a sealing element disposed between the carrier housing and the axle tube housing to form a substantially fluid-tight seal therebetween; and
a fastener configured to couple the carrier housing to the axle tube housing forming a bolted joint between the carrier housing and the axle tube housing, wherein the bolted joint is nonorthogonal relative to a centerline of the axle shaft.

11. A method of producing an axle assembly, comprising:
providing a carrier housing;
providing an axle tube housing configured to receive an axle shaft therein; and
coupling the axle tube housing to the carrier housing, wherein a joint formed between the axle tube housing and the carrier housing is nonorthogonal relative to a centerline of the axle shaft.

12. The method of claim 11, wherein an angle of a sealing surface of the carrier housing relative to the centerline of the axle shaft is equivalent to a predetermined draft angle of an interior surface of the carrier housing.

13. The method of claim 11, wherein an angle of a sealing surface of the axle tube housing relative to the centerline of the axle shaft is equivalent to a predetermined draft angle of an interior surface of the carrier housing.

14. The method of claim 11, wherein an angle of a sealing surface of the carrier housing relative to the centerline of the axle shaft is less than 90 degrees.

15. The method of claim 11, wherein an angle of a sealing surface of the carrier housing relative to the centerline of the axle shaft is more than 90 degrees.

16. The method of claim 11, wherein an angle of a sealing surface of the axle tube housing relative to the centerline of the axle shaft is less than 90 degrees.

17. The method of claim 11, wherein an angle of a sealing surface of the axle tube housing relative to the centerline of the axle shaft is more than 90 degrees.

18. The method of claim 11, wherein the axle tube housing is coupled to the carrier housing by at least one fastener extending outwardly from an interior of the carrier housing into at least one aperture formed in the axle tube housing.

19. The method of claim 11, wherein at least one of the carrier housing and the axle tube housing is formed by a casting process.
